(19) United States
(12) Patent Application Publication
(10) Pub. No.: US 2020/0218263 A1
(43) Pub. Date: Jul. 9, 2020

(54) SYSTEM AND METHOD FOR EXPLAINING ACTIONS OF AUTONOMOUS AND SEMI-AUTONOMOUS VEHICLES

(71) Applicant: Intuition Robotics, Ltd., Ramat-Gan (IL)

(72) Inventors: Roy AMIR, Mikhmoret (IL); Itai MENDELSOHN, Tel Aviv-Yafo (IL); Dor SKULER, Oranit (IL); Shay ZWEIG, Harel (IL)

(73) Assignee: Intuition Robotics, Ltd., Ramat-Gan (IL)

(21) Appl. No.: 16/737,209

(22) Filed: Jan. 8, 2020

Related U.S. Application Data
(60) Provisional application No. 62/789,734, filed on Jan. 8, 2019.

(51) Int. Cl. G05D 1/00; G06N 3/04

(52) U.S. Cl. CPC G05D 1/0088; G05D 2201/0213; G06N 3/0445; G06N 3/0454

(57) ABSTRACT

A system and method for explaining actions of a vehicle, including: receiving an indication associated with at least one action of the vehicle; receiving a data input from the vehicle, wherein the data input is associated with at least one of: an external environment of the vehicle and an internal environment of the vehicle; analyzing the indication with respect to the data input to determine when it is desirable to provide an explanation for the at least one action of the vehicle; selecting, when it is desirable to provide an explanation for the at least one action, a predetermined plan including an explanation of the at least one action, wherein the selection is based on the analysis of the indication with respect to the data input; and, executing the predetermined plan.

### CROSS-REFERENCE TO RELATED APPLICATIONS

This application claims the benefit of U.S. Provisional Application No. 62/789,734 filed on Jan. 8, 2019, the contents of which are hereby incorporated by reference.

### TECHNICAL FIELD

The present disclosure relates generally to autonomous and semi-autonomous vehicles' systems, and more specifically to a system and method thereof for explaining actions of autonomous and semi-autonomous vehicles to a variety of users.

### BACKGROUND

The field of autonomous driving is growing and an increasing rate, with many options related to fully autonomous vehicles, semi-autonomous or partially autonomous vehicles, and the like, becoming available to end consumers for the first time. Many related novel features are being introduced in conventional vehicles as well, such as lane assist and rear end collision prevention technologies. These features range from a simple informative alert, such as an icon notification of the presence of a vehicle in a blind spot, to the fully autonomous driving of a vehicle when a user needs only to sit back in their seat and watch a car take them from a point of origin to their destination without any human input.

Many passengers in such vehicles are, and will be, unfamiliar with the manner in which these vehicles are configured to operate. Some of the actions taken by these vehicles may seem unnatural or counterintuitive to a user experiencing these vehicles as a passive passenger. Further, even when the vehicle performs an action that a human driver would have otherwise performed, such as stopping short or swerving when an animal enters the vehicular path, the movement of the vehicle can seem unnerving to a passive passenger, as they may be paying less attention to their environment than a conventional driver would, and not expect certain vehicle movements.

While explanations of what actions the vehicle is taking and why they are being performed can be displayed to the passengers, e.g., on an internal screen, too much or too little information can become a nuisance or concerning, respectively, for a passenger. Furthermore, what may be the correct amount of explanation and information to put one passenger as ease, can easily fall short or overload another. Thus, an ideal system would have the ability to discern the type of passenger or passengers currently within a vehicle, and determine the preferred amount and type of explanation for upcoming, current, and past vehicle actions.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for explaining actions of a vehicle, including: receiving at least one indication associated with at least one action of the vehicle; receiving at least one data input from the vehicle, wherein the at least one data input is associated with at least one of: an external environment of the vehicle and an internal environment of the vehicle; analyzing the at least one indication with respect to the at least one data input to determine when it is desirable to provide an explanation for the at least one action of the vehicle; selecting, when it is desirable to provide an explanation for the at least one action, at least one predetermined plan including an explanation of the at least one action, wherein the selection is based on the analysis of the at least one indication with respect to the at least one data input; and, executing the at least one predetermined plan.

Certain embodiments disclosed herein also include a non-transitory computer readable medium having stored thereon instructions for causing a processing circuitry to perform a process, the process including: receiving at least one indication associated with at least one action of the vehicle; receiving at least one data input from the vehicle, wherein the at least one data input is associated with at least one of: an external environment of the vehicle and an internal environment of the vehicle; analyzing the at least one indication with respect to the at least one data input to determine when it is desirable to provide an explanation for the at least one action of the vehicle; selecting, when it is desirable to provide an explanation for the at least one action, at least one predetermined plan including an explanation of the at least one action, wherein the selection is based on the analysis of the at least one indication with respect to the at least one data input; and, executing the at least one predetermined plan.

Certain embodiments disclosed herein also include a system for explaining actions of a vehicle, including: a processing circuitry; and a memory, the memory containing instructions that, when executed by the processing circuitry, configure the system to: receive at least one indication associated with at least one action of the vehicle; receive at least one data input from the vehicle, wherein the at least one data input is associated with at least one of: an external environment of the vehicle and an internal environment of the vehicle; analyze the at least one indication with respect to the at least one data input to determine when it is desirable to provide an explanation for the at least one action of the vehicle; select, when it is desirable to provide an explanation for the at least one action, at least one predetermined plan including an explanation of the at least one action, wherein the selection is based on the analysis of the at least one indication with respect to the at least one data input; and, execute the at least one predetermined plan.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system utilized for explaining actions of autonomous and semi-autonomous vehicles according to an embodiment.

FIG. 2 is a block diagram of an agent controller according to an embodiment.

FIG. 3 is a flowchart illustrating a method for explaining actions of autonomous and semi-autonomous vehicles according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

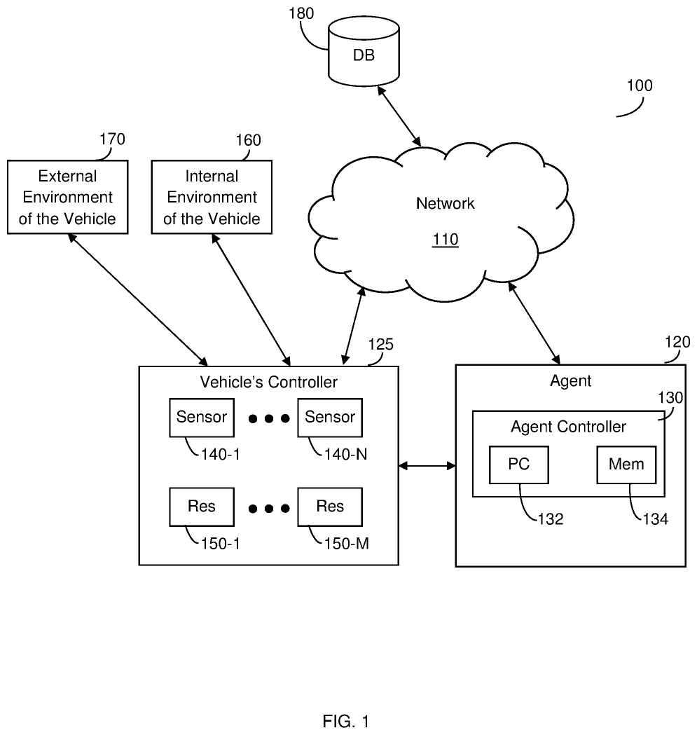

FIG. 1 is a network diagram of a system 100 for explaining actions of autonomous and semi-autonomous vehicles according to an embodiment. The system 100 includes an agent 120, a vehicle's controller 125, a vehicle's internal environment 160, and a vehicle's external environment 170. In some embodiments, the agent 120 is further connected to a network, where the network 110 is used to communicate between different parts of the system 100. The network 110 may be, but is not limited to, a local area network (LAN), a wide area network (WAN), a metro area network (MAN), the Internet, a wireless, cellular or wired network, and the like, and any combination thereof.

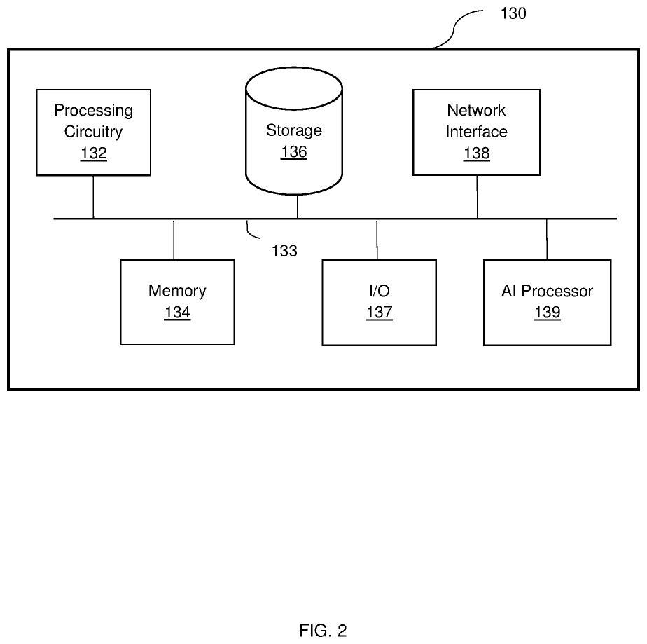

The vehicle may be a fully autonomous vehicle, a semi-autonomous vehicle, a partially autonomous vehicle, a traditional vehicle, an aerial vehicle, a vessel, a combination thereof, and the like. An occupant of the vehicle may access the agent 120 directly, e.g., via a voice command or an input device connected directly to the agent 120, or indirectly through the network 110, e.g., through an application on a mobile phone connected to the internet, where the agent 120 is additionally connected to the internet. The agent 120 includes an agent controller 130, explained in more detail below in FIG. 2, having at least a processing circuitry 132 and a memory 134.

The vehicle's controller 125 may be an electronic module designed to control the operation of a vehicle, such as an autonomous vehicle, a semi-autonomous vehicle, a traditional vehicle, and so on. The vehicle's controller 125 may include one or more sensors 140-1 to 140-N, where N is an integer equal to or greater than 1 (hereinafter referred to as sensor 140 or sensors 140 merely for simplicity) and one or more resources 150-1 to 150-M, where M is an integer equal to or greater than 1 (hereinafter referred to as resource 150 or resources 150 merely for simplicity). The sensors 140 may include input devices, such as various sensors, detectors, microphones, touch sensors, movement detectors, cameras, and the like. Any of the sensors 140 may be, but are not necessarily, communicatively or otherwise connected to the vehicle's controller 125. In an embodiment, the sensors 140 as well as the resources 150 may be connected to and controlled by the agent controller 130 of the agent 120.

The sensors 140 may be configured to detect signals from the internal environment 160 of the vehicle and from the external environment 170 of the vehicle. To that end, the sensors may be positioned both inside the vehicle and outside the vehicle. Internal sensors may be configured to detect, for example, passenger voice inputs, internal temperature, number of passengers in the vehicle, type of passengers in the vehicle, and the like. External sensors may be configured to determine, for example, the time of day, amount of ambient light, objects on the road or next to the road, nearby vehicles, and the like.

The resources 150 may include display units, audio speakers, lighting system, and the like available for use by the vehicle. In an embodiment, the resources 150 may encompass sensors 140 as well. As a non-limiting example, the resources 150 may include a vehicle's sound system, vehicle's display unit, head-up display (HUD), and so on. In an embodiment, the resources 150 may also be components of the vehicle, such as windows, trunk, windshield wipers, and the like.

According to another embodiment, the agent 120 may have a direct link to, for example, the vehicle's controller 125, a controller area network (CAN) bus of the vehicle, and the like, for the purpose of receiving data inputs, e.g., from the sensors 140, and execute plans as further described herein below. For example, the agent 120 may receive signals indicating that the battery is drained or that there is an engine malfunction from the CAN bus. As another example, the agent 120 may send a signal to the CAN bus to switch the windshield wipers on. The agent 120 may receive a signal from the vehicle's controller 125 indicating a decision to slow down the vehicle immediately based on data input received from external sensors.

The agent 120 uses the agent controller 130 for identifying actions to be performed by the vehicle and provide explanations to the occupants of the vehicle when such an explanation is desirable. Explaining the action of the vehicle allows the occupants of the vehicle to understand the logic behind the vehicle's decisions and actions, allowing the occupants of the vehicle to trust the vehicle's decisions and actions.

In one embodiment, the system 100 further includes a database 180. The database may be stored within the agent 120 (e.g., within a storage device not shown), or may be separate from the agent 120 and connected thereto via the network 110. The database 180 may store one or more predetermined plans to be executed, using the resources 150 of the vehicle, as further discussed herein below.

According to another embodiment, the database 180 may store therein historical data associated with one or more occupants of the vehicle. The historical data may be retrieved from the database 180 and used for determining, for example, how to identify current occupants of the vehicle, and the most effective way for using the resources 150 considering a specific identified occupant of the vehicle. For example, when an occupant is identified as an elder who is not familiar with autonomous or semi-autonomous vehicles, the agent controller 130 is be configured to explain simple actions such as changing lanes in the highway. However, when the occupant is identified as an individual experienced with autonomous vehicles, explanations regarding changing lanes in the highway will not be generated.

FIG. 2 shows an exemplary and non-limiting schematic block diagram of an agent controller 130 according to an embodiment. The agent controller 130 includes a processing circuitry 132 configured to receive data, analyze data, generate outputs, and the like, as further described herein below. The processing circuitry 132 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The agent controller 130 further includes a memory 134. The memory 134 may contain therein instructions that, when executed by the processing circuitry 132, cause the agent controller 130 to execute actions as further described herein below. The agent controller 130 may include hardware, software, a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause a processing circuitry 132 to perform the various processes described herein.

The memory 134 may further store therein information, e.g., data associated with predetermined plans that may be executed by one or more resources, e.g., the resources 150 of FIG. 1. As discussed above, the resources 150 include means by which an agent of a vehicle interacts with one or more occupants of the vehicle, collects data related to the occupants of the vehicle, and the like. The resources 150 may include, for example, electro-mechanical elements, sensors, detectors, display units, speakers, microphones, touch sensors, light sensors, movement detectors, cameras, and the like.

In an embodiment, the agent controller 130 includes a network interface 138 configured to connect to a network, such as the network 110 of FIG. 1. The network interface 138 may include, but is not limited to, a wired interface (e.g., an Ethernet port) or a wireless port (e.g., an 802.11 compliant Wi-Fi card) configured to connect to a network.

In an embodiment, the agent controller 130 includes an input/output (I/O) interface 137 configured to connect to and control the resources 150. In an embodiment, the I/O interface 137 is configured to receive one or more signals captured by sensors 140 and send them to the processing circuitry 132 for analysis. According to an embodiment, the I/O interface 137 is configured to analyze the signals captured by the sensors 140, detectors, and the like. According to a further embodiment, the I/O interface 137 is configured to send one or more commands to one or more of the resources 150 for executing one or more plans for explaining the vehicle's decisions and actions. A plan may include for example, generating a textual notification, a vocal notification, display a graphic explanation on the display unit, generating a customized plan with respect to a specific occupant that was identified in the vehicle, and so on.

In an embodiment, the agent controller 130 further includes an artificial intelligence (AI) processor 139. The AI processor 139 may be realized as one or more hardware logic components and circuits, including graphics processing units (GPUs), tensor processing units (TPUs), neural processing units, vision processing unit (VPU), reconfigurable field-programmable gate arrays (FPGA), and the like. The AI processor 139 is configured to perform machine learning based on an indication associated with at least one action of the vehicle, discussed below, and data input received from one or more sources such as the sensors 140, vehicle's controller 125, global positioning system (GPS) of the vehicle, and so on.

In an embodiment, the AI processor 139 is further configured to determine, based on one or more machine learning models, whether it is desirable to provide an explanation to actions that are about to be performed by the vehicle, currently being performed, or have been previously performed. In an embodiment, the AI processor 139 is further configured to select one or more predetermined plans and may also customize the plans with respect to a specific occupant of the vehicle for the purpose of explaining the vehicle's actions. In an embodiment, the machine learning techniques employed by the AI processor 139 include implementation of one or more neural networks, recurrent neural networks, decision tree learning, Bayesian networks, clustering, and the like, based on the data inputs.

In an embodiment, the agent controller 130 receives at least one indication associated with at least one action of the vehicle. The indication may be indicative of a current action of the vehicle, an upcoming action, or a previous action. The indication may be received by, for example, identifying a transmission transferred from at least one controller area network (CAN) bus to the vehicle's controller 125. The indication may indicate regarding, for example, a command to use the brakes for stopping the vehicle, a command to change lanes, a command to accelerate, and the like. The indication may also be indicative of the character of the command, i.e., whether the command to stop requires a lot of energy in order to perform an emergency stop, or a lower energy level for performing a regular stop when approaching a traffic light. In an embodiment, the indication may further include an explanation for the at least one action. For example, the reasoning for performing a hard stop is the detection that a dog has jumped into the middle of the road. In an embodiment, the indication may be received directly from one or more sensors, e.g. the sensors 140.

In an embodiment, the agent controller 130 receives at least one data input. The data input may be associated with the external environment of the vehicle, the internal environment of the vehicle, and the like. The data input that is associated with the external environment may indicate on an exact location of an obstacle that is located in front of the vehicle, a person that is walking on a sidewalk and getting too close to the road, and the like. The data input that is associated with the internal environment may indicate regarding, for example, the identity of one or more occupants of the vehicle, the preferences of one or more occupants that were identified, the interaction between the occupants, the interaction between the agent 120 (shown in FIG. 1) and at least one occupant, the temperature within the vehicle's cabin, whether all occupants fastened their seatbelts or not, and so on. It should be noted that the data input in both cases, i.e., internal environment and external environment, may be received from, for example, a set of sensors, e.g., the sensors 140, the Internet, one or more databases, the occupant's calendar, and the like.

In an embodiment, the agent controller 130 analyzes the at least one indication with respect to the received at least one data input. For example, an indication that the vehicle is about to perform a hard brake is identified and analyzed with respect to data inputs indicating that 100 meters ahead a car has crashed into a safety fence. According to the same example, the received data input may indicate that there is only one person in the vehicle, the identity of the person, the preferred way of communication of the specific identified person, and the like. The analysis may be achieved using one or more machine learning techniques, computer vision, audio signal processing techniques, and the like.

In an embodiment, the agent controller 130 determines, based on the analysis, whether it is desirable to provide an explanation to the at least one action. For example, when an indication that an autonomous vehicle is about to normally accelerate to 60 miles per hour, the road is clear, and the occupants of the vehicle are properly seated, providing an explanation to the normal acceleration may not be desirable. However, when the indication indicates that the autonomous vehicle is about to perform a hard brake, as two kids are identified running after a ball and towards the road, providing an explanation to the hard brake may be desirable.

In an embodiment, the agent controller 130 may be further configured to assess the mental state of the at least one occupant, e.g., based on data input from the sensor 140, and use the assessment to determine if, when, and how to provide an explanation to the vehicle's actions. For example, when the occupant is determined to be in an anxiety state, e.g., based on recorded audio from the vehicle interior, the agent controller 130 may provide more explanations regarding the vehicle's actions, more detailed explanations, and the like. The assessment of the mental state may be achieved, for example, using one or more machine learning techniques.

Based on determination that it is desirable to provide an explanation to the action, the agent controller 130 selects at least one predetermined plan designed to explain the action. The predetermined plan may include, for example, a textual notification, a vocal notification, a graphic explanation, a customized plan that is associated with a specific occupant that has been identified in the vehicle, a combination thereof, and the like. The plan may be selected from a plurality of predetermined plans that may be stored in a database, e.g., the database 180. The selection of the at least one predetermined plan is based on the analysis of the at least one indication with respect to the received at least one data input. For example, if an indication of a hard brake was received, and the data input indicates that a cat is crossing the road 20 meters in front of the autonomous vehicle, a plan that includes a vocal explanation explaining that a cat is crossing the road and therefore the vehicle will perform an emergency brake, is selected. According to an embodiment, the selected plan may be customized with respect to the occupant of the vehicle, the number of occupants, the occupant's state, time of day, whether at least one of the occupants is sleeping, and the like.

In an embodiment, the agent controller 130 executes the selected at least one predetermined plan. The execution of one or more plans that are utilized to provide an explanation to the vehicle's actions may be performed using one or more resources of the vehicle. It should be noted that the explanation may be executed before the action is performed, while the action is performed, or after the action is performed.

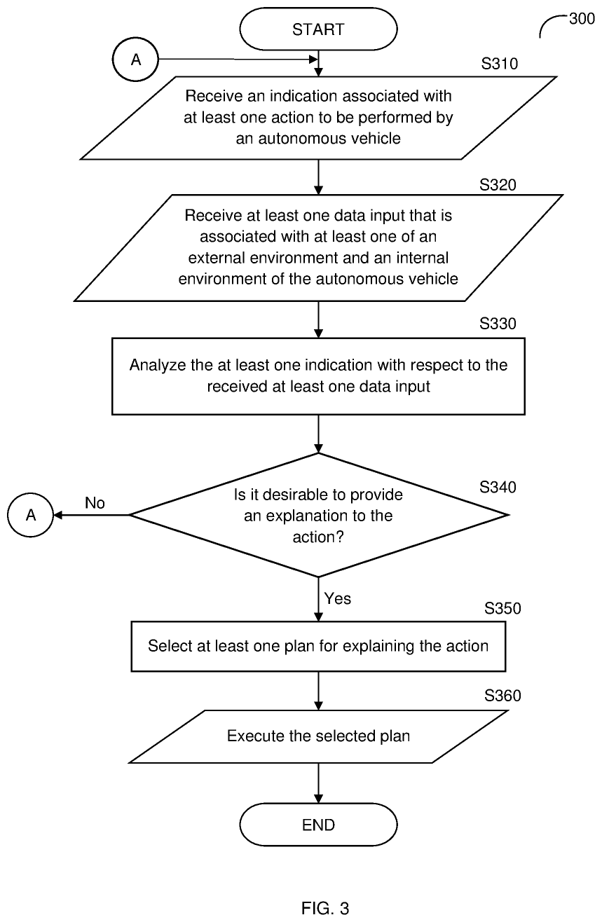

FIG. 3 shows an example flowchart 300 illustrating a method for explaining decisions and actions of a vehicle, such as an autonomous vehicle. It should be noted that while the discussed method focuses on an autonomous vehicle, the method applies equally to a fully autonomous vehicle, a semi-autonomous vehicle, a partially autonomous vehicle, a traditional vehicle, an aerial vehicle, a vessel, a combination thereof, and the like.

At S310, at least one indication associated with at least one action to be performed by an autonomous vehicle is received. The action may be for example, to accelerate the vehicle, to change lanes, and the like. The indication may be received by an agent 120 (shown in FIG. 1) from a vehicle's controller 125 (shown in FIG. 1). In an embodiment, the indication may further include an explanation for the at least one action. For example, the reasoning for performing a hard stop is that it has been determined that a dog has jumped into the middle of the road.

At S320, at least one data input is received. The data input may be associated with the external environment of the autonomous vehicle and/or an internal environment of the autonomous vehicle. The data input may include sensory data, data received from the Internet, data retrieved from databases, data received from data sources, a combination thereof, and the like.

At S330, the at least one indication is analyzed with respect to the received at least one data input. The analysis may be achieved using, for example, one or more machine learning techniques, computer vision, audio signal processing techniques, and the like. In an embodiment, the machine learning techniques may include one or more signal processing techniques, implementation of one or more neural networks, recurrent neural networks, decision tree learning, Bayesian networks, clustering, and the like, based on the data inputs.

At S340, it is determined, based on the analysis of the at least one indication and the at least one data input, whether it is desirable to provide an explanation to the at least one action, and if so, execution continues with S350; otherwise, execution continues with S310.

At S350, at least one predetermined plan designed to explain the at least one action is selected. The selection is based on the analysis of the at least one indication with respect to the received at least one data input as further discussed herein above. In an embodiment, the at least one predetermined plan is accessed from a database, e.g., over a network connection.

At S360, the selected predetermined plan is executed. The execution of the plan may be achieved using one or more resources, e.g., the resources 150.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for explaining actions of a vehicle, comprising:
receiving at least one indication associated with at least one action of the vehicle;
receiving at least one data input from the vehicle, wherein the at least one data input is associated with at least one of: an external environment of the vehicle and an internal environment of the vehicle;
analyzing the at least one indication with respect to the at least one data input to determine when it is desirable to provide an explanation for the at least one action of the vehicle;
selecting, when it is desirable to provide an explanation for the at least one action, at least one predetermined plan including an explanation of the at least one action, wherein the selection is based on the analysis of the at least one indication with respect to the at least one data input; and,
executing the at least one predetermined plan.

2. The method of claim 1, wherein the vehicle is at least one of: an autonomous vehicle, a semi-autonomous vehicle, a partially autonomous vehicle, a traditional vehicle, an aerial vehicle, and a vessel.

3. The method of claim 1, wherein the at least one indication further comprises an explanation for the at least one action.

4. The method of claim 1, wherein the analysis further comprises at least one machine learning technique.

5. The method of claim 4, wherein the machine learning technique includes at least one of: a signal processing technique, implementation of one or more neural networks, recurrent neural networks, decision tree learning, Bayesian networks, and clustering.

6. The method of claim 1, wherein the determination of when it is desirable to provide an explanation for the at least one action is based on a machine learning technique.

7. The method of claim 1, wherein the selected at least one predetermined plan comprises at least a reason for at least one of: an upcoming action, an action that is currently performed, and an action that was previously performed.

8. The method of claim 1, wherein the at least one indication is indicative of at least one of: a current action of the vehicle, an upcoming action of the vehicle, and a previous action of the vehicle.

9. The method of claim 1, wherein the data input is received from one or more sensors connected to the vehicle.

10. A non-transitory computer readable medium having stored thereon instructions for causing a processing circuitry to perform a process, the process comprising:
receiving at least one indication associated with at least one action of a vehicle;
receiving at least one data input from the vehicle, wherein the at least one data input is associated with at least one of: an external environment of the vehicle and an internal environment of the vehicle;
analyzing the at least one indication with respect to the at least one data input to determine when it is desirable to provide an explanation for the at least one action of the vehicle;
selecting, when it is desirable to provide an explanation for the at least one action, at least one predetermined plan including an explanation of the at least one action, wherein the selection is based on the analysis of the at least one indication with respect to the at least one data input; and,
executing the at least one predetermined plan.

11. A system for explaining actions of a vehicle, comprising:
a processing circuitry; and
a memory, the memory containing instructions that, when executed by the processing circuitry, configure the system to:
receive at least one indication associated with at least one action of the vehicle;
receive at least one data input from the vehicle, wherein the at least one data input is associated with at least one of: an external environment of the vehicle and an internal environment of the vehicle;
analyze the at least one indication with respect to the at least one data input to determine when it is desirable to provide an explanation for the at least one action of the vehicle;
select, when it is desirable to provide an explanation for the at least one action, at least one predetermined plan including an explanation of the at least one action, wherein the selection is based on the analysis of the at least one indication with respect to the at least one data input; and,
execute the at least one predetermined plan.

12. The system of claim 11, wherein the vehicle is at least one of: an autonomous vehicle, a semi-autonomous vehicle, a partially autonomous vehicle, a traditional vehicle, an aerial vehicle, and a vessel.

13. The system of claim 11, wherein the at least one indication further comprises an explanation for the at least one action.

14. The system of claim 11, wherein the analysis further comprises at least one machine learning technique.

15. The system of claim 14, wherein the machine learning technique includes at least one of: a signal processing technique, implementation of one or more neural networks, recurrent neural networks, decision tree learning, Bayesian networks, and clustering.

16. The system of claim 11, wherein the determination of when it is desirable to provide an explanation for the at least one action is based on a machine learning technique.

17. The system of claim 11, wherein the selected at least one predetermined plan comprises at least a reason for at least one of: an upcoming action, an action that is currently performed, and an action that was previously performed.

18. The system of claim 11, wherein the at least one indication is indicative of at least one of: a current action of the vehicle, an upcoming action of the vehicle, and a previous action of the vehicle.

19. The system of claim 11, wherein the data input is received from one or more sensors connected to the vehicle.
